(19) United States
(12) Patent Application Publication
(10) Pub. No.: US 2025/0136800 A1
(43) Pub. Date: May 1, 2025

(54) PEROXIDE-CROSSLINKABLE RUBBER COMPOSITIONS CONTAINING ORGANIC FILLERS

(71) Applicant: Suncoal Industries GmbH, Ludwigsfelde (DE)

(72) Inventors: Alexander Stücker, Ludwigsfelde (DE); Gerd Schmaucks, Ludwigsfelde (DE); Tobias Wittmann, Ludwigsfelde (DE); Jacob Podschun, Ludwigsfelde (DE); Bernhard Schwaiger, Erftstadt (DE)

(73) Assignee: Suncoal Industries GmbH, Ludwigsfelde (DE)

(21) Appl. No.: 18/685,327

(22) PCT Filed: Aug. 23, 2022
(86) PCT No.: PCT/EP2022/073490

§ 371 Date: Feb. 21, 2024

(30) Foreign Application Priority Data
Aug. 23, 2021 (EP) 21192648.0
Sep. 28, 2021 (EP) 21199589.9

(51) Int. Cl. C08L 23/16; C08K 3/04; C08K 3/22; C08K 5/14

(52) U.S. Cl. CPC C08L 23/16; C08K 3/04; C08K 3/22; C08K 5/14; C08K 2003/2296; C08L 2205/22; C08L 2310/00; C08L 2312/02

(57) ABSTRACT

The present invention relates to a vulcanizable rubber composition, comprising a vulcanization system VS that comprises at least one peroxide, a rubber component K containing at least one rubber that is cross-linkable by means of the at least one peroxide of the VS, and a filler component F containing at least one organic filler that has a ¹⁴C content in a range from 0.20 to 0.45 Bq/g carbon and a d99 value of <25.0 μm, to a kit of parts comprising, as part (A), a rubber composition containing the above-mentioned components K and F and, as part (B), the vulcanization system VS comprising at least the at least one peroxide, to vulcanized rubber compositions respectively obtainable therefrom, to a use of one of the above-mentioned products for employment in the production of technical rubber articles, preferably those having a sealing function, to corresponding technical rubber articles as such, preferably those having a sealing function, as well as to a use of the organic filler for increasing the elongation at break and at the same time decreasing the compression set in vulcanized rubber compositions.

The present invention relates to a vulcanizable rubber composition, comprising a vulcanization system VS that comprises at least one peroxide, a rubber component K containing at least one rubber that is cross-linkable by means of the at least one peroxide of the VS, and a filler component F containing at least one organic filler that has a ¹⁴C content in a range from 0.20 to 0.45 Bq/g carbon and a d99 value of <25.0 μm, to a kit of parts comprising as part (A) a rubber composition containing the above-mentioned components K and F and as part (B) the vulcanization system VS comprising at least the at least one peroxide, to vulcanized rubber compositions respectively obtainable therefrom, to a use of one of the above-mentioned products for employment in the production of technical rubber articles, preferably those having a sealing function, to corresponding technical rubber articles as such, preferably those having a sealing function, as well as to a use of the organic filler for increasing the elongation at break and at the same time decreasing the compression set in vulcanized rubber compositions.

### State of the Art/Background of the Invention

The use of reinforcing fillers in rubber compositions is known in the prior art. In particular, industrial carbon blacks such as furnace carbon blacks should be mentioned here that are used for this purpose. Industrial carbon blacks continue to represent the largest amount of reinforcing fillers. Industrial carbon blacks are produced on the basis of highly aromatic petrochemical oils by means of incomplete combustion or pyrolysis of hydrocarbons. From an environmental point of view, it is however desirable to avoid the use of fossil energy sources for the production of fillers, or to reduce it to a minimum. It is particularly serious to note here that for the production of one ton of industrial carbon black, about 1 ton of CO₂ is released in the production process, depending on the specific surface area of the carbon black. In addition, industrial carbon blacks may often not be usable for certain applications for color reasons.

For rubber compositions that contain reinforcing fillers, there is a variety of different fields of application. They can, for example, be employed in the tire industry, but also in the field of technical rubber articles, here for example for the provision of corresponding articles with good sealing function, such as elastomer seals. Elastomer seals usually have to guarantee their sealing function over a long period of time under different and even changing operating conditions, for example at high temperatures and/or high pressures.

The most important cross-linking method in the rubber industry is sulfur vulcanization. However, elastomers cross-linked by means of sulfur often do not have sufficient heat resistance and too high a deformation set, which is why this cross-linking method is often disadvantageous in the field of vulcanization of rubber compositions for the production of the technical rubber articles mentioned above with the intended good sealing function, such as for the production of elastomer seals, and is therefore not the cross-linking method of choice. Cross-linking by means of peroxide is the second most important cross-linking method for rubber, after the vulcanization by means of sulfur. Cross-linking by means of peroxide is of great technical importance, especially for rubbers that do not have double bonds in the main chain, such as EPDM. Compared to elastomers cross-linked by means of sulfur, elastomers cross-linked by means of peroxide usually have better heat resistance (stable C-C bonding) and a low deformation set.

In order to obtain predictions about the load-bearing capacity of rubber compositions that are used for manufacturing seals, for example, the so-called compression set (DVR, German for Druckverformungsrest) is often measured under the conditions of use or under more stringent conditions such as for example higher temperatures. The compression set indicates the amount of deformation of a sample body that remains after the load has been removed. The compression set test is used for the assessment of the viscoelastic behavior of elastomers under prolonged static deformation by compression. As a comparative test method, it serves for the assessment of elastomers for employment as sealing elements, damping elements for mechanical engineering and much more. By means of the compression set it is therefore possible to determine the percentage of deformation that remains in elastomers in relation to the initial deformation after prolonged, constant pressure loading and subsequent relaxation. It is an important factor that describes the mechanical ageing of elastomers in relation to their recovery after deformation such as pressure and/or stress. This ageing also influences the chemical ageing processes, such as thermal-oxidative ageing, for example. In order to obtain predictions about the load-bearing capacity of rubber compositions that are used to manufacture seals, for example, the tensile-elongation behavior is also tested in addition to the compression set, for example at room temperature and after hot air ageing. Usually, both high elongation at break at room temperature and low compression set are aimed for. In the case of the peroxide cross-linking mentioned above, both properties are generally dependent on the cross-linking density of the peroxide cross-linking and are often controlled by the dosage of the peroxides and possibly of certain co-agents that are also used. However, the higher the cross-linking density, the lower is usually both the elongation at break and the compression set, while a low elongation at break, as mentioned above, is disadvantageous, in particular, as mentioned above, with regard to ageing, but also with regard to the cracking properties. These two properties-elongation at break and cross-linking density-cannot usually be optimized independently of each other when using conventional reinforcing fillers such as carbon black and inorganic fillers such as silicic acids.

Therefore, there is a need for new rubber compositions that are cross-linkable by means of peroxide and do not exhibit the disadvantages mentioned hereinabove.

### Object

It is therefore an object of the present invention to provide rubber compositions vulcanizable by means of peroxide which are suited to enable the provision of technical rubber articles and/or components of these articles, in particular those having an excellent sealing function, wherein the rubber compositions vulcanized by means of peroxide which are obtainable therefrom not only have to show high heat resistance but also should be characterized by both high elongation at break and at the same time low compression sets. In particular, the new rubber compositions vulcanizable by means of peroxide should allow for an optimal adjustment and balance of these two parameters, and thereby have advantages regarding the ageing and cracking properties, among others.

### Solution

This object is achieved by the subject matters claimed in the patent claims as well as the preferred embodiments of these subject matters as described in the following specification.

A first subject matter of the present invention is a vulcanizable rubber composition comprising a rubber component K, a filler component F and a vulcanization system VS, wherein
the vulcanization system VS comprises at least one peroxide,
the rubber component K contains at least one rubber that is cross-linkable by means of the at least one peroxide of the vulcanization system VS, and
the filler component F contains at least one organic filler that has a ¹⁴C content in a range from 0.20 to 0.45 Bq/g carbon and has a d99 value of <25.0 μm.

Another subject of the present invention is a kit of parts, comprising, in spatially separated form,
as part (A), a rubber composition at least containing the above-mentioned rubber component K employed according to the invention and at least the filler component F employed according to the invention, wherein part (A) of the kit of parts does not comprise, however, the at least one peroxide of the vulcanization system VS employed according to the invention, and
as part (B), a vulcanization system VS employed according to the invention that comprises at least one peroxide.

Another subject matter of the present invention is a vulcanized rubber composition that can be obtained by vulcanization of the vulcanizable rubber composition according to the invention or by vulcanization of a vulcanizable rubber composition obtainable by combining and mixing the two parts (A) and (B) of the kit of parts according to the invention.

Another subject matter of the present invention is a use of the vulcanizable rubber composition according to the invention, of the kit of parts according to the invention or the vulcanized rubber composition according to the invention for use in the production of technical rubber articles, preferably in the production of technical rubber articles having a sealing function, in particular of seals, profiles, dampers, rings and hoses.

Another subject matter of the present invention is a technical rubber articles, preferably those having a sealing function, produced by employing the vulcanizable rubber composition according to the invention, the kit of parts according to the invention, or the vulcanized rubber composition according to the invention, in particular a seal, a profile, a damper, a ring or a hose.

Another subject matter of the present invention is a use of the organic filler employed according to the invention for increasing the elongation at break and at the same time decreasing the compression set in vulcanized rubber compositions that are obtainable by vulcanization by means of at least one peroxide, wherein the vulcanizable rubber compositions used for this purpose contain, in addition to the at least one peroxide and the organic filler, at least one rubber that is cross-linkable by means of the at least one peroxide.

It has been found that the organic filler employed according to the invention is an environmentally friendly alternative, both to known, in particular inorganic fillers, as well as to carbon blacks for rubber applications that are cross-linked by means of peroxide. Further, it has been found that the organic filler employed according to the invention is directly suitable as such for incorporation into rubber compositions, in particular for producing technical rubber articles, preferably those having a sealing function, such as profiles, seals, dampers, rings and/or hoses.

In addition, it has been found that the rubber compositions according to the invention are characterized by both high elongation at break as well as only low compression set after a vulcanization by means of peroxide. Furthermore, it has been shown that an optimum balance of these two parameters to be adjusted can be achieved by means of the vulcanizable rubber composition according to the invention. It has been found in this context that these advantageous effects are due to the use of the organic filler employed according to the invention in the rubber composition. In particular, it has surprisingly been found that the organic filler employed according to the invention is chemically integrated into the polymer cross-linking in the temperature and time window given for vulcanization by means of peroxide. With this bonding of the reinforcing filler, in particular by utilizing the specific surface chemistry of the organic filler employed according to the invention, parts of the polymer chains of the rubber are restricted in their mobility, which leads to an increase in the storage modulus during dynamic deformations and lowers the loss modulus. This advantageous special feature of the organic filler employed according to the invention therefore makes it possible to reduce the polymer-polymer cross-linking and still achieve a low compression set and a high elongation at break.

It has been found that the rubber compositions according to the invention not only exhibit high thermal resistance after vulcanization, but also improved, namely reduced, compression sets, which is particularly relevant when the resulting products are used in the field of technical rubber articles such as in seals, dampers, hoses, and rings such as O-rings. In particular, it has surprisingly been found that an at least partial replacement of industrial carbon black by the organic filler employed according to the invention in rubber compounds cross-linked by means of peroxide leads to an improvement, that is, a decrease of the compression set, and this in particular already at a significantly lower cross-linking density as compared with rubber compounds containing industrial carbon black and cross-linked by means of peroxide. This makes it possible to set a high elongation at break, in particular, so that the field of operation for a targeted adjustment of rubber properties can be widened.

Further, it has surprisingly been found that the rubber compositions according to the invention, in particular after a vulcanization, can be used in elastomer parts having a sealing function and elastomer parts having dynamic properties or low set behavior.

### DETAILED DESCRIPTION

The term “comprising” as used in the present invention in connection with, for example, the vulcanizable rubber compositions according to the invention and the process steps or stages in the context of processes described herein, preferably has the meaning “consisting of.” In this context, for example, with regard to the vulcanizable rubber compositions according to the invention, one or more of the further constituents optionally contained that are mentioned below may also be contained therein—in addition to the constituents necessarily present therein. All the constituents may be present in each of their preferred embodiments mentioned below. With regard to the processes according to the invention and described herein, these may have further optional process steps and stages in addition to the mandatory steps and/or stages.

The amounts of all the constituents contained in the compositions described herein, such as the vulcanizable rubber compositions according to the invention (comprising in each case all the mandatory constituents and, in addition, all the optional constituents), add up in total to 100% by weight, respectively.

### Vulcanizable Rubber Composition

The vulcanizable rubber composition according to the invention comprises a rubber component K, a filler component F and a vulcanization system VS.

Preferably, the vulcanization system VS does not contain any free sulfur, and in particular, the vulcanizable rubber composition according to the invention as such does not contain any free sulfur. In other words, the vulcanizable rubber composition according to the invention is preferably not vulcanizable by a sulfur vulcanization, which could possibly take place before, after or simultaneously with the peroxide cross-linking. Preferably, the vulcanizable rubber composition according to the invention is thus cross-linked by means of peroxide exclusively.

### Filler Component F

The filler component F of the vulcanizable rubber composition according to the invention comprises at least one organic filler.

Since the filler employed according to the invention filler is of organic nature, inorganic fillers such as precipitated silicic acids do not fall under this category.

The terms filler, and organic filler in particular, are known to the person skilled in the art. Preferably, the organic filler employed according to the invention is a reinforcing filler, i.e., an active filler. Reinforcing or active fillers, in contrast to inactive (non-reinforcing) fillers, can change the viscoelastic properties of a rubber by interacting with the rubber within a rubber composition. For example, they can influence the viscosity of the rubbers and can improve the fracture behavior of the vulcanizates, for example with regard to tear strength, tear propagation resistance and abrasion. Inactive fillers, on the other hand, dilute the rubber matrix.

The organic filler employed according to the invention has a ¹⁴C content in a range from 0.20 to 0.45 Bq/g carbon, preferably 0.23 to 0.42 Bq/g carbon. The required ¹⁴C content cited above is achieved by organic fillers obtained from biomass, by further treatment or reaction of the same, preferably by fractioning, wherein the fractioning can be carried out thermally, chemically and/or biologically, and preferably is carried out thermally and chemically. Thus, filler obtained from fossil materials, such as fossil fuels in particular, do not fall under the definition of the fillers according to the invention to be employed according to the invention, since they do not possess a corresponding ¹⁴C content.

Herein, biomass is in principle defined as any biomass, wherein the term “biomass” herein includes so-called phytomass, i.e. biomass originating from plants, zoomass, i.e. biomass originating from animals, and microbial biomass, i.e. biomass originating from microorganisms including fungi, the biomass is dry biomass or fresh biomass, and it originates from dead or living organisms. The biomass particularly preferred herein for the production of the fillers is phytomass, preferably dead phytomass. Dead phytomass comprises, among other things, dead, rejected or detached plants and their parts. These include, for example, broken and torn leaves, cereal stalks, side shoots, twigs and branches, the fallen leaves, felled or pruned trees, as well as seeds and fruits and parts derived therefrom, but also sawdust, wood shavings/chips and other products derived from wood processing.

Preferably, the organic filler has a carbon content in a range from >60% by weight to <90% by weight, particularly preferably from >60% by weight to <85% by weight, more particularly preferably from >60% by weight to <82% by weight, more preferably from >60% by weight to <80% by weight, relative to the ash-free and water-free filler, respectively. One method for the determination of the carbon content is cited in the Methods section below. In this respect, the organic filler differs both from carbon blacks, such as industrial carbon blacks, made of fossil raw materials, as well as from carbon blacks made of regrowing raw materials, since carbon blacks have a corresponding carbon content of at least 95% by weight.

Preferably, the organic filler has an oxygen content in a range from >8% by weight to <30% by weight, particularly preferably from >10% by weight to <30% by weight, more particularly preferably from >15% by weight to <30% by weight, still more particularly preferably from >20% by weight to <30% by weight, relative to the ash-free and water-free filler, respectively. The oxygen content can be determined by high-temperature pyrolysis, for example using the EuroEA3000 CHNS-O Analyzer of the company EuroVector S.p.A.

Preferably, the organic filler has a BET surface area (specific total surface area according to Brunauer, Emmett and Teller) in a range from >10 to <150 m²/g, particularly preferably in a range from 20 to 120 m²/g, more preferably in a range from 30 to 110 m²/g, in particular in a range from 40 to 100 m²/g, most preferably in a range from 40 to <100 m²/g.

Preferably, the organic filler has an STSA surface area in a range from 10 to <200 m²/g. A method for the determination of the STSA surface area (Statistical Thickness Surface Area) is cited in the Methods section below. Preferably, the organic filler has an STSA surface area in a range from 10 to 150 m²/g, in particular in a range from 20 to 120 m²/g, more particularly preferably in a range from 30 to 110 m²/g, in particular in a range from 40 to 100 m²/g, most preferably in a range from 40 to <100 m²/g.

Preferably, the organic filler has at least one functional group that is selected from phenolic OH groups, phenolate groups, aliphatic OH groups, carboxylic acid groups, carboxylate groups and mixtures thereof.

Preferably, the organic filler employed according to the invention is a lignin-based organic filler produced from biomass and/or biomass components. For example, the lignin for the production of the lignin-based organic filler may be isolated and extracted from biomass and/or dissolved. Suitable methods for obtaining the lignin for the production of the lignin-based organic filler from biomass are, for example, hydrolytic methods or pulping methods, such as the Kraft pulping method. The term “lignin-based”as used in the present invention preferably means that one or more lignin units and/or one or more lignin scaffolds are present in the organic filler employed according to the invention. Lignins are solid biopolymers that are incorporated into plant cell walls and thus effect the lignification of plant cells. As such, they are present in biomass and in particular in biologically regrowing raw materials, and they therefore represent—in particular in hydrothermally treated form-an environmentally friendly filler alternative.

Preferably, the lignin, and preferably the organic filler employed according to the invention as such, if it is a lignin-based filler, is present at least partially in hydrothermally treated form, and is particularly preferably obtainable by means of hydrothermal treatment in each case. Particularly preferably, the organic filler employed according to the invention is based on lignin that can be obtained by hydrothermal treatment. Suitable methods of the hydrothermal treatment, in particular of lignins and lignin-containing organic fillers, are described in WO 2017/085278 A1 and WO 2017/194346 A1 as well as in EP 3 470 457 A1, for example. Preferably, the hydrothermal treatment is carried out at temperatures >100° C. to <300° C., particularly preferably >150° C. to <250° C., in the presence of liquid water. Preferably, the organic filler is a lignin-based filler, wherein preferably at least the lignin and even more preferably, the organic filler as such, is present at least partially in a form that can be obtained by means of hydrothermal treatment, and particularly preferably can be obtained by means of hydrothermal treatment, wherein the hydrothermal treatment preferably has been carried out at a temperature in a range from >100° C. to <300° C., particularly preferably from >150° C. to <250° C. Optionally, the starting material used for this purpose, such as a lignin-containing raw material, in particular a lignin, can be reacted with at least one cross-linking agent already before the hydrothermal treatment is carried out. The cross-linking agent preferably has at least one functional group that can react with the cross-linkable groups of the lignin. The cross-linking agent preferably has at least one functional group selected from aldehyde, carboxylic acid anhydride, epoxide, hydroxyl and isocyanate groups, or a combination thereof. Preferably, the cross-linking agent is selected from aldehydes, epoxides, acid anhydrides, polyisocyanates and/or polyols, in particular from aldehydes such as formaldehyde, furfural and/or sugar aldehydes. In the process, the cross-linking agent can react with free ortho and para positions of the phenolic rings, with aromatic and aliphatic OH groups, and/or with carboxyl groups of the lignin.

Preferably, the organic filler has a pH value in a range from 7 to 9, particularly preferably in a range from >7 to <9, more particularly preferably in a range from >7.5 to <8.5.

The organic filler employed according to the invention has a d99 value of <25.0 μm. The method for the determination of the d99 value is described below in the Methods section and is carried out by means of laser diffraction according to ISO 13320:2009. The d90 and d25 values cited hereinafter are determined in the same way. The person skilled in the art will be aware that the organic filler employed according to the invention is present in the form of particles, and that the average particle size (average grain size) of these particles is described by the d99 value mentioned above, and by the d90 and d25 values also mentioned above.

Preferably, the organic filler has a d99 value of <20.0 μm, more preferably of <15.0 μm, particularly preferably of <10 μm, more particularly preferably of <9.0 μm, more preferably of <8.0 μm, more preferably of <7.0 μm, most preferably of <6.0 μm, preferably determined by means of laser diffraction according to ISO 13320:2009, respectively.

Preferably, the organic filler has a d90 value of <7.0 μm, particularly preferably of <6.0 μm, more particularly preferably of <5.0 μm, and/or preferably has a d25 value of <3.0 μm, particularly preferably of <2.0 μm, more particularly preferably of <1.0 μm, preferably determined by means of laser diffraction according to ISO 13320:2009, respectively.

Preferably, the rubber composition contains the at least one organic filler in a quantity lying in a range from 10 to 150, particularly preferably from 15 to 130, more particularly preferably from 20 to 120, even more preferably from 30 to 100 phr, most preferably 40 to 80 phr.

The phr (parts per hundred parts of rubber by weight) specification used herein is the quantity specification commonly used in the rubber industry for compound formulations. The dosage of the parts by weight of the individual constituents is always relative to 100 parts by weight of the total mass of all rubbers present in the compound.

In addition to the at least one organic filler employed according to the invention, the filler component F may contain one or more other filler(s) that differ from the organic filler employed according to the invention. Preferably, the proportion in phr of the at least one organic filler employed according to the invention in the rubber composition is higher than the corresponding proportion of the one or more further filler(s).

In the case that the organic filler according to the invention serves only as a partial replacement of common industrial carbon blacks, the rubber compositions according to the invention may also contain industrial carbon blacks, in particular furnace carbon blacks, as classified as general-purpose carbon blacks under ASTM Code N550, for example. This is particularly true for such industrial carbon blacks that can be subsumed under ASTM Code N550 and have an STSA surface area in a range from 8 to 150 m²/g. Alternatively, or in addition, the rubber compositions according to the invention may also contain carbon blacks which are not subsumed under the ASTM code mentioned above, in particular those having an STSA surface area in a range from 20 to 60 m²/g.

In addition, or as an alternative, the rubber compositions according to the invention may contain inorganic fillers, in particular, for example those having a different particle size, particle surface and chemical nature with different potential to influence the vulcanization behavior. In the event that further fillers are included, these should preferably have properties as similar as possible to the organic fillers according to the invention employed in the rubber composition according to the invention, especially with regard to their pH values.

If other fillers are employed, they are preferably phyllosilicates such as clay minerals, for example talc; carbonates such as calcium carbonate; silicates such as for example calcium, magnesium, and aluminum silicates; and oxides such as for example magnesium oxide and silica or silicic acid.

In particular in the case that the organic filler employed according to the invention serves only as a partial replacement for common silicic acids or silica, the rubber compositions according to the invention may also contain such inorganic fillers such as silica or silicic acid.

However, in the context of the present invention, zinc oxide does not fall under the inorganic fillers, since zinc oxide is taking the task of an additive promoting vulcanization. Additional fillers must however be chosen with care, since silica tends to bind organic molecules to its surface and thus inhibit their action.

Inorganic fillers, among them preferably silica and other fillers, which carry Si—OH groups on their surface, may be surface-treated (surface-modified). In particular, a silanization with organosilanes, such as for example alkylalkoxysilanes or aminoalkylalkoxysilanes or mercaptoalkylalkoxysilanes, may be of advantage. The alkoxysilane groups can, for example, bind to the surfaces of silicates or silica, or to other suitable groups, by hydrolytic condensation.

The fillers different from the organic fillers according to the invention may be used individually or in combination with each other. In the event that other fillers are used, their proportion is preferably less than 40 phr, particularly preferably 20 to 40 phr and particularly preferably 25 to 35 phr.

### Rubber Component K

The rubber component K of the vulcanizable rubber composition according to the invention comprises at least one rubber that is cross-linkable by the at least one peroxide of the vulcanization system VS.

Any kind of rubber is suitable for the production of the rubber compositions according to the invention, as long as it can be cross-linked by means of at least one peroxide. Suitable rubbers, both natural rubbers (NR) as well as synthetic rubbers, are known to the person skilled in the art. Rubbers that cannot be cross-linked by means of peroxides are for example chlorinated isobutene-isoprene rubbers (CIIR; chloro-isobutene-isoprene rubber), isobutene-isoprene rubbers (IIR), epichlorohydrin rubbers (ECO/CO/ETER) and propylene oxide rubbers (GPO).

Preferably, the at least one rubber of the rubber component K is selected from group consisting of rubbers without carbon-carbon double bonds in their main chain, preferably without any carbon-carbon double bonds within their whole structure, particularly preferably selected from the group consisting of HNBR (hydrated acrylonitrile-butadiene rubbers), ethylene-propylene-diene rubbers (EPDM), ethylene-propylene rubbers (EPM), acrylate-ethylene rubbers (AEM), ethylene-vinyl acetate rubbers (EVM), chlorinated rubbers, in particular chlorinated polyethylenes (CM), silicone rubbers (Q), chlorosulfonated polyethylenes (CSM), fluoro-rubber elastomers (FPM) and mixtures thereof.

### Vulcanization System VS

The vulcanization system VS of the vulcanizable rubber composition according to the invention comprises at least one peroxide. Peroxide functions as the vulcanizing agent.

The vulcanizable rubber compositions according to the invention can be vulcanized due to the presence of the vulcanization system VS and the peroxide contained therein.

The vulcanization reaction is initiated by the thermal decomposition of the peroxide, which leads to the formation of two radicals. The radical transfer to the rubber is effected either by substitution of a hydrogen atom or by addition to a double bond of the polymer, if one is present. The efficiency of cross-linking can be significantly improved by using radical-transferring substances, so-called co-agents. Depending on its structure and the co-agent present, the rubber polymer radical can react in different ways.

The at least one peroxide of the vulcanization system VS preferably comprises, in particular represents, at least one organic peroxide, particularly preferably an organic peroxide selected from the group consisting of dialkyl peroxides, alkyl aryl peroxides, diaryl peroxides, alkyl peracid esters, aryl peracid esters, diacyl peroxides, polyvalent peroxides and mixtures thereof, more particularly preferably an organic peroxide selected from the group consisting of di-tert.-butyl peroxide, 2,5-dimethyl-2,5-di(tert.-butyl-peroxy) hexane, dicumyl peroxide, tert.-butylcumyl peroxide, tert.-butyl peroxybenzoate, dibenzoyl peroxide, 1,1-di(tert.-butylperoxy)-3,3,5-trimethyl cyclohexane and bis-(tert.-butylperoxy)-diisopropylbenzene as well as mixtures thereof.

The proportion of peroxide in the rubber compositions according to the invention is preferably 0.5 to 10 phr, particularly preferably 1.0 to 8 phr and particularly preferably 1.5 to 6 phr.

Preferably, the rubber composition, particularly preferably the vulcanization system VS of the rubber composition, comprises at least one at least monounsaturated and preferably polyunsaturated organic compound, which preferably is selected from the group consisting of di-(meth)acrylates, dimaleinimides, triallyl compounds and unsaturated polymers such as 1,2-polybutadiene and trans-polyoctenamere, preferably having a number-average molecular weight (Mn) of <10,000 g/mol, particularly preferably of <5,000 g/mol, more particularly preferably of <2,500 g/mol, more preferably of <1,500 g/mol, in particular of <1,000 g/mol, most preferably of <500 g/mol, respectively, as well as mixtures thereof, particularly preferably is selected from the group consisting of ethylene glycoldi(meth)acrylate (EDMA), trimethylolpropane tri(meth)acrylate (TRIM), N,N′-m-Phenylene bismaleimide (MPBM), diallylterephthalate (DATP), triallylcyanurate (TAC), 1,4-butandiol di(meth)acrylate and mixtures thereof. The at least one at least monounsaturated and preferably polyunsaturated organic compound preferably functions as the above-mentioned co-agent in order to increase the cross-linking yield and thereby achieve better results for the compression set. Co-agents bridge steric effects and suppress reactions that are inactive with regard to cross-linking.

The proportion of the co-agent in the rubber composition according to the invention is preferably 0.5 to 10 phr, particularly preferably 1.0 to 8 phr and particularly preferably 1.5 to 6 phr.

The vulcanization system VS of the vulcanizable rubber composition according to the invention may contain one or more other vulcanizing agents than peroxide, and/or additives promoting vulcanization such as zinc oxide and/or fatty acids, such as stearic acid.

The vulcanization system VS of the vulcanizable rubber composition according to the invention may contain one or more additives that promote vulcanization, but cannot initiate it by themselves. Such additives include, for example, vulcanization accelerators such as saturated fatty acids with 12 to 24, preferably 14 to 20 and particularly preferably 16 to 18 carbon atoms, such as stearic acid and the zinc salts of the fatty acids mentioned above, for example. Thiazoles may also belong to these additives.

If vulcanization-promoting additives and in particular the above-mentioned fatty acids and/or their zinc salts, preferably stearic acid and/or zinc stearate, are used in the rubber compositions according to the invention, their proportion is 0 to 10 phr, particularly preferably 1 to 8 phr and particularly preferably 2 to 6 phr.

The vulcanization system VS of the vulcanizable rubber composition according to the invention may moreover contain one or more further vulcanizing agents that differ from peroxide, such as preferably zinc oxide. It is particularly preferred to use such vulcanizers of the vulcanization system VS in addition to peroxide.

If further vulcanizing agents such as zinc oxide are used in the rubber compositions according to the invention, their proportion is preferably 0 to 10 phr, more preferably 1 to 8 phr and particularly preferably 2 to 6 phr.

It is also possible to add free sulfur as a further vulcanizing agent to the VS vulcanization system, in addition to at least one peroxide. This, however, is not preferred, as already mentioned hereinabove.

The vulcanization of the rubber compositions of the present invention is carried out preferably using at least one peroxide, such as in particular at least one organic peroxide in combination with zinc oxide and/or, preferably and, at least one fatty acid.

### Other Constituents of the Vulcanizable Rubber Composition

The rubber composition according to the invention may contain further optional constituents, such as plasticizers/softening agents and/or antidegradants and/or resins, in particular resins that increase adhesion.

With the use of softening agents, it is possible to influence properties of the unvulcanized rubber composition, such as processability, in particular, but also properties of the vulcanized rubber composition, such as its flexibility, especially at low temperatures. Particularly suitable softening agents in the context of the present invention are mineral oils from the group of paraffinic oils (substantially saturated chain-shaped hydrocarbons) and naphthenic oils (substantially saturated ring-shaped hydrocarbons). It is also possible, and even preferred, to employ aromatic hydrocarbon oils. However, with regard to the adhesion of the rubber composition to other rubber-containing components in tires, such as for example the carcass, a mixture of paraffinic and/or naphthenic oils could also be advantageous as softening agent. Other possible softening agents are for example esters of aliphatic dicarboxylic acids, such as for example adipic acid or sebacic acid, paraffin waxes and polyethylene waxes. Among the softening agents, paraffinic oils and naphthenic oils are particularly suitable in the context of the present invention; most preferred are however aromatic oils, in particular aromatic mineral oils.

Preferably, softening agents, and among them particularly preferred the paraffinic and/or naphthenic, and in particular aromatic process oils, are employed in a quantity of 0 to 100 phr, preferably 10 to 70 phr, particularly preferably 20 to 60 phr, in particular 20 to 50 phr.

Examples of antidegradants are quinolines such as TMQ (2,2,4-trimethyl-1,2-dihydroquinoline) and diamines such as 6-PPD (N-(1,3-dimethylbutyl)-N′-phenyl-p-phenylene diamine).

So-called adhesion-enhancing resins can be used to improve the adhesion of the vulcanized rubber compound of the present invention to other adjacent rubber components. Particularly suitable resins are those based on phenol, preferably from the group consisting of phenolic resins, phenol-formaldehyde resins and phenol-acetylene resins. In addition to the phenolic-based resins, aliphatic hydrocarbon resins such as Escorez™ 1102 RM from the company ExxonMobil, as well as aromatic hydrocarbon resins, may also be used. Aliphatic hydrocarbon resins particularly improve adhesion to other rubber components of the tire. They generally have lower adhesion than the resins based on phenol and may be used either alone or as a mixture with the resins based on phenol.

If the adhesion-enhancing resins are used at all, then preferably those selected from the group consisting of resins based on phenol, aromatic hydrocarbon resins and aliphatic hydrocarbon resins. Preferably, their proportion is 0 to 15 phr or 1 to 15 phr, particularly preferably 2 to 10 phr and more particularly preferably 3 to 8 phr.

### Kit of Parts

Another subject of the present invention is a kit of parts, comprising, or preferably consisting of, in spatially separated form,
as part (A), a rubber composition at least containing the above-mentioned rubber component K employed according to the invention and at least the filler component F employed according to the invention, wherein part (A) of the kit of parts does not comprise, however, the at least one peroxide of the vulcanization system VS employed according to the invention, and as part (B), a vulcanization system VS employed according to the invention that comprises at least one peroxide.

Thus, part (A) is not vulcanizable as such by means of peroxide, and thus represents at this point of time a rubber composition that is not vulcanizable by means of peroxide. The vulcanization by means of peroxide is only possible after mixing the parts (A) and (B).

Preferably, the components K and F of the rubber composition according to the invention on the one hand and the vulcanization system VS on the other hand are spatially separated from each other in the kit of parts and can thus be stored. The kit of parts serves for the preparation of a vulcanizable rubber composition. For example, the rubber composition according to the invention constituting one part of the kit of parts and comprising the components K and F and possibly other constituents including vulcanizing agents other than peroxide, such as zinc oxide and/or at least one fatty acid, may be used as part (A) in stage 1 of the process described hereinbelow for preparing a vulcanizable rubber compound, and the second part of the kit of parts, i.e., the vulcanization system VS, may be used as part (B) comprising at least the peroxide in stage 2 of said process.

In contrast to the vulcanizable rubber composition that contains, preferably in a homogenous mixture, the constituents K and F of the rubber composition according to the invention as well as the associated vulcanization system VS comprising the at least one peroxide, so that the vulcanizable rubber composition can be vulcanized directly, the rubber composition comprising the components K and F and the vulcanization system VS comprising the at least one peroxide are thus spatially separated from each other in the kit of parts.

All preferred embodiments described hereinabove in connection with the vulcanizable rubber composition according to the invention are also preferred embodiments with regard to the kit of parts according to the invention.

Preferably, the kit of parts according to the invention comprises, as
part (A), a rubber composition comprising at least the components K and F, and as
part (B), a vulcanization system VS comprising at least one peroxide and furthermore zinc oxide, wherein zinc oxide may alternatively be present within part (A).

Particularly preferably, the kit of parts according to the invention comprises, as
part (A), a rubber composition comprising at least the components K and F, and as
part (B),a vulcanization system comprising at least one peroxide, zinc oxide and at least one saturated fatty acid such as stearic acid and/or optionally zinc stearate,
wherein at least zinc oxide and/or the fatty acid may alternatively be present within part (A).

### Process for Preparing the Vulcanizable Rubber Composition

Another subject matter of the present invention is a process for preparing the vulcanizable rubber composition according to the invention.

All preferred embodiments described hereinabove in connection with the vulcanizable rubber composition according to the invention and the kit of parts according to the invention are also preferred embodiments with regard to the process according to the invention.

The production of the vulcanizable rubber composition according to the invention is preferably carried out in two stages, in the stages 1 and 2 described in more detail hereinbelow. However, as explained further below, a single-stage process control is also possible as an alternative.

### Two-Stage Process

In the first stage (stage 1), a rubber composition as a base mixture (masterbatch) is first prepared by mixing all constituents employed for the preparation of the vulcanizable rubber composition according to the invention with each other, but without the at least one peroxide. In the second stage (stage 2) at least the peroxide, and optionally additional constituents of the vulcanization system VS, are admixed to the rubber composition obtained after stage 1.

### Stage 1

Preferably, the at least one rubber contained in the rubber component of the rubber composition K according to the invention, as well as resins different therefrom that may optionally be employed, preferably those that improve adhesion, are provided. However, the latter may alternatively also be added subsequently together with further additives. Preferably, the rubbers have at least room temperature (23° C.) or are preferably employed after being preheated to temperatures of at maximum 50° C., preferably at maximum 45° C. and particularly preferably at maximum 40° C. Particularly preferably, the rubbers are pre-masticated for a short period of time before the other constituents are added. If inhibitors such as magnesium oxide are used for subsequent vulcanization control, they are preferably also added at this point of time.

Then, at least one organic filler employed according to the invention, and optionally further fillers, are added, preferably with the exception of zinc oxide, since this is used as a constituent of the vulcanization system in the rubber compositions according to the invention, as mentioned hereinabove, and is therefore not considered as a filler herein. Preferably, the addition of the at least one organic filler and optionally other fillers is carried out in increments.

Advantageously, but not mandatorily, softening agents and other constituents such as vulcanizing agents other than peroxide, such as for example stearic acid and/or zinc stearate and/or zinc oxide, are added only subsequently to the addition of the at least one organic filler or the other fillers, if used. This facilitates the incorporation of the at least one organic filler, and if present, the other fillers. It may be advantageous, however, to incorporate a part of the organic filler, or, if present, the other fillers, together with the softening agents and any other constituents optionally used.

The highest temperatures obtained during the preparation of the rubber composition in the first stage (“dump temperature”) should not exceed 170° C., since there is the possibility of partial decomposition of the reactive rubbers and/or the organic fillers above these temperatures. Depending in particular from the rubber employed, temperatures of >170° C., for example up to <200° C., may also be possible. Preferably, the maximum temperature in the preparation of the rubber composition of the first stage is between 80° C. and <200° C., particularly preferably between 90° C. and 190° C., most preferably between 95° C. and 170° C.

The mixing of the constituents of the rubber composition is usually carried out by means of internal mixers equipped with tangential or meshing (i.e., intermeshing) rotors. The latter usually allow for better temperature control. Mixers with tangential rotors are also referred to as tangential mixers. However, mixing can also be carried out using a double-roll mixer, for example. Depending on the rubber employed, the mixing process can be carried out conventionally, starting with addition of the polymer, or upside down, that is, in the end after addition of all other constituents of the mixture. The upside-down approach is mostly used for the rubbers EPM and EPDM.

After the preparation of the rubber composition, it is preferably cooled down before carrying out the second stage. A process of this type is also referred to as maturing. Typical maturing periods are 6 to 24 hours, preferably 12 to 24 hours.

### Stage 2

In the second stage, at least the peroxide, but preferably additional constituents of the vulcanization system VS, are incorporated into the rubber composition of the first stage, thereby obtaining a vulcanizable rubber composition according to the present invention. Preferably, the co-agent, if present/used, is also incorporated at stage 2.

If zinc oxide and in addition optionally at least one saturated fatty acid such as stearic acid are employed as the vulcanization system in addition to peroxide, the addition of all these constituents may take place in stage 2. It is however also possible to integrate these constituents, with the exception of the peroxide, into the rubber composition already in stage 1.

The highest temperatures obtained during the preparation of the admixture of the vulcanization system to the rubber composition in the second stage (“dump temperature”) must remain below the temperature at which the cleavage of the peroxide starts and should preferably not exceed 130° C., particularly preferably 125° C. A preferred temperature range is between 70° C. and 125° C., particularly preferably 80° C. and 120° C. At temperatures above the maximal temperature for the cross-linking system of 105° C. to 120° C., premature vulcanization might occur.

After admixing the vulcanization system in stage 2, the composition is preferably cooled down.

In the above-mentioned two-stage process, a rubber composition is thus first obtained in the first stage, which is supplemented in the second stage to form a vulcanizable rubber composition.

### Single-Stage Process

In the case of the one-stage process, all constituents used to produce the vulcanizable rubber composition according to the invention are mixed together within one stage, including the vulcanization system. Preferably, the peroxide of the vulcanization system, preferably together with the co-agent, is only added to the rubber compound after the total amount of rubber employed and the total amount of filler employed as well as any additional constituents have been added. Preferably, the addition of the filler employed is carried out in such a way that it is added in at least two portions at different times, wherein the entire amount of rubber employed preferably has already been provided at the time of the first addition. Specifically in the case of the single-stage process, there is no cooling/no relaxation before the addition of the constituents of the vulcanization system.

### Process for Further Processing the Vulcanizable Rubber Composition According to the Invention

Before vulcanization, the vulcanizable rubber compositions thus prepared go through deformation processes that are preferably customized or tailored for the final articles. Rubber compositions are formed into a suitable shape as required for the vulcanization process, preferably by extrusion or calendering. In the process, vulcanization may be carried out in vulcanization molds by means of pressure and temperature, or the vulcanization is carried out without pressure in temperature-controlled channels in which air or liquid materials provide heat transfer.

### Vulcanized Rubber Composition

Another subject matter of the present invention is a vulcanized rubber composition that can be obtained by vulcanization of the vulcanizable rubber composition according to the invention or by vulcanization of a vulcanizable rubber composition obtainable by combining and mixing the two parts (A) and (B) of the kit of parts according to the invention.

All preferred embodiments described hereinabove in connection with the vulcanizable rubber composition according to the invention and the kit of parts according to the invention as well as with the process according to the invention are also preferred embodiments with regard to the vulcanized rubber composition according to the invention.

Typically, vulcanization is carried out under pressure and/or under heat. Suitable vulcanization temperatures are preferably from 140° C. to 200° C., particularly preferably from 150° C. to 180° C. Optionally, vulcanization is carried out at a pressure in the range of 50 to 175 bar. It is however also possible to carry out the vulcanization in a pressure range from 0.1 to 1 bar, for example in the case of profiles.

The vulcanized rubber compositions obtained from the vulcanizable rubber compositions according to the invention preferably have a Shore A hardness in the range from more than 40 to less than 80, particularly preferably from 45 to 75 and most preferably from 50 to 70, and/or a tensile strength in the range of more than 8 MPa, particularly preferably of more than 8.5 MPa, more particularly preferably of more than 9 MPa, and/or an elongation at break of >300%, preferably of >350%, particularly preferably of >400%, and/or a compression set (after 22 h at 70° C.) of at most 13.0%, preferably of <13.0% and/or a compression set (after 22 h at 100° C.) of at most 20.0%, preferably of <20.0%, particularly preferably of <19.5%. The methods for determining Shore A hardness, tensile strength, elongation at break and compression set are given hereinbelow in the description of the methods.

### Use

Another subject matter of the present invention is a use of the vulcanizable rubber composition according to the invention, of the kit of parts according to the invention or the vulcanized rubber composition according to the invention for use in the production of technical rubber articles, preferably in the production of technical rubber articles having a sealing function.

All preferred embodiments described hereinabove in connection with the vulcanizable rubber composition according to the invention, the kit of parts according to the invention, the process according to the invention and the vulcanized rubber composition according to the invention are also preferred embodiments with regard to the above-mentioned use according to the invention.

The term “technical rubber articles” (also mechanical rubber goods, MRG) is known to the person skilled in the art. Examples for technical rubber articles are profiles, seals, dampers and/or hoses.

### Technical Rubber Article

Another subject matter of the present invention is a technical rubber article, preferably those having a sealing function, that is produced employing the vulcanizable rubber composition according to the invention, the kit of parts according to the invention or the vulcanized rubber composition according to the invention.

All preferred embodiments described hereinabove in connection with the vulcanizable rubber composition according to the invention, the kit of parts according to the invention, the process according to the invention and the vulcanized rubber composition according to the invention as well as the use according to the invention are also preferred embodiments with regard to the above-mentioned technical rubber articles according to the invention.

### Use of the Organic Filler Employed According to the Invention

Another subject matter of the present invention is a use of the organic filler employed according to the invention for increasing the elongation at break and at the same time decreasing the compression set in vulcanized rubber compositions that are obtainable by vulcanization by means of at least one peroxide, wherein the vulcanizable rubber compositions used for this purpose contain, in addition to the at least one peroxide and the organic filler, at least one rubber that is cross-linkable by means of the at least one peroxide.

All preferred embodiments described hereinabove in connection with the vulcanizable rubber composition according to the invention, the kit of parts according to the invention, the process according to the invention and the vulcanized rubber composition according to the invention, the above-mentioned technical rubber articles according to the invention as well as the use according to the invention are also preferred embodiments with regard to the use according to the invention of the organic filler employed according to the invention. Elongation at break and compression set are determined as described in the “Methods” section hereinbelow.

### Determination Methods

### 1. Determination of the ¹⁴C Content

The determination of the ¹⁴C content (content of biologically based carbon) is carried out by means of the radiocarbon method according to DIN EN 16640:2017-08.

### 2. Determination of the Particle Size Distribution

The particle size distribution can be determined by laser diffraction of the material dispersed in water (1% by weight in water) according to ISO 13320:2009, with an ultrasound treatment of 12,000 Ws being carried out before the measurement. The volume fraction is specified, for example, as d99 in μm (the diameter of the grains of 99% of the volume of the sample is below this value).

### 3. Determination of Carbon Content

The carbon content is determined by elemental analysis according to DIN 51732:2014-7.

### 4. Determination of Oxygen Content

The oxygen content is determined by high-temperature pyrolysis using the EuroEA3000 CHNS-O analyzer of the company EuroVector S.p.A. Here, the CHNS content is determined by means of the above-mentioned analysis apparatus, the oxygen content is subsequently calculated as the difference (100-CHNS).

### 5. Determination of Dry Matter Content of the Organic Fillers Employed

The dry matter content of the sample as determined along the lines of DIN 51718:2002-06 as follows. For this purpose, the MA100 moisture balance from the company Sartorius was heated to a dry temperature of 105° C. The dry sample, if not already in powder form, was mortared or ground to a powder. Approximately 2 g of the sample to be measured was weighed on a suitable aluminum pan in the moisture balance and then the measurement was started. As soon as the weight of the sample did not change by more than 1 mg for 30 s, this weight was considered constant and the measurement was terminated. The dry matter content then corresponds to the displayed content of the sample in % by weight. At least one duplicate determination was performed for each sample. The weighted mean values were reported. 6. Determination of the pH Value of the organic fillers employed

The pH was determined following ASTM D 1512 standard as follows. The dry sample, if not already in powder form, was mortared or ground to a powder. In each case, 5 g of sample and 50 g of fully deionized water were weighed into a glass beaker. The suspension was heated to a temperature of 60° C. with constant stirring using a magnetic stirrer with heating function and stirring flea, and the temperature was maintained at 60° C. for 30 min. Subsequently, the heating function of the stirrer was deactivated so that the mixture could cool down while stirring. After cooling, the evaporated water was replenished by adding fully deionized water again and stirred again for 5 min. The pH value of the suspension was determined with a calibrated measuring instrument. The temperature of the suspension should be 23° C. (+0.5° C.). A duplicate determination was performed for each sample and the averaged value was reported.

### 7. Determination of the Ash Content of the Organic Fillers

The water-free ash content of the samples was determined by thermogravimetric analysis in accordance with the DIN 51719 standard as follows: Before weighing, the sample was ground or mortared. Prior to ash determination, the dry substance content of the weighed—in material is determined. The sample material was weighed to the nearest 0.1 mg in a crucible. The furnace, including the sample, was heated to a target temperature of 815° C. at a heating rate of 9° K/min and then held at this temperature for 2 h. The furnace was then cooled to 300° C. before the samples were taken out. The samples were cooled to ambient temperature in the desiccator and weighed again. The remaining ash was correlated to the initial weight and thus the weight percentage of ash was determined. Triplicate determinations were performed for each sample, and the averaged value was reported.

### 8. Determination of the BET and STSA Surface Area of the Organic Fillers

The specific surface area of the filler to be investigated was determined by nitrogen adsorption according to the ASTM D 6556 (2019-01-01) standard provided for industrial carbon blacks. According to this standard, the BET surface area (specific total surface area according to Brunauer, Emmett and Teller) and the external surface area (STSA surface area; Statistical Thickness Surface Area) were determined as follows.

The sample to be analyzed was dried to a dry matter content ≥97.5% by weight at 105° C. prior to the measurement. In addition, the measuring cell was dried in a drying oven at 105° C. for several hours before weighing in the sample. The sample was then filled into the measuring cell using a funnel. In case of contamination of the upper measuring cell shaft during filling, it was cleaned using a suitable brush or a pipe cleaner. In the case of strongly flying (electrostatic) material, glass wool was weighed in additionally into the sample. The glass wool was used to retain any material that might fly up during the bake-out process and contaminate the device.

The sample to be analyzed was baked out at 150° C. for 2 hours, and the Al₂O₃ standard was baked out at 350° C. for 1 hour. The following N2 dosage was used for the determination, depending on the pressure range:

p/p0=0-0.01: N₂ dosage: 5 ml/g

p/p0=0.01-0.5: N₂ dosage: 4 ml/g.

To determine the BET, extrapolation was performed in the range of p/p0=0.05−0.3 with at least 6 measurement points. To determine the STSA, extrapolation was performed in the range of the layer thickness of the adsorbed N₂ from t=0.4−0.63 nm (corresponding to p/p0=0.2-0.5) with at least 7 measurement points.

### 9. Determination of Hardness

The determination of the Shore A hardness of vulcanized rubber compositions was carried out in accordance with ISO 48-4:2021-02 at 23° C., using the digital Shore hardness tester from the company Sauter GmbH. In order to reach the thickness of the test specimen of at least 6 mm as required by the standard, the test specimen was composed of not more than three layers. For this purpose, 3 S2 bars, punched out to perform the tensile test according to ISO 37:2011, were stacked on top of each other. Five measurements were taken on each sample stack at different points on the stack. The results obtained represent the average value of these five measurements. Between vulcanization and testing, the samples were stored for at least 16 h at room temperature in the laboratory.

### 10. Determination of Cross-Linking Density/Reaction Kinetics

The cross-linking density and the reaction kinetics of the rubber compositions were determined according to DIN 53529-3:1983-06 at 175° C., but at a deflection of 3°. The measuring time was 15 min. In the process, the minimum and the maximum torque (M_{L}, M_{H}) were determined. From these, the difference A (M_{H}−M_{L}) was calculated (maximum torque minus minimum torque). Furthermore, the time periods were determined in which the torque, starting from the time of the minimum torque M_{L}, reaches 10%, 50% and 90% of the maximum torque M_{H}, respectively. The time periods were designated as T10, T50 and T90.

### 11. Determination of Elongation Under Tension

The elongation under tension, including tensile strength and elongation at break, was determined on vulcanized rubber compositions according to ISO 37:2011.

### 12. Determination of Deformation by Compression

The deformation by compression was determined on vulcanized rubber compositions according to DIN ISO 815-1:2016-09. Three test specimens were tested per sample. Immediately before vulcanization, the mixture was plasticized on a roller to improve the flowing behavior. Care was taken to ensure that the mixture was warm to the touch with the bare hand. Strips corresponding to the width of the cavities in the mold were cut out of the approximately 7 mm thick roll sheet to prevent long flow paths, which have an influence on the strength. The pressure of the vulcanization press was 200 bar. A pre-programmed pressing cycle was used to vulcanize the test specimens according to the table below:

| Cycle step | Value | Heating rate [° C./min] |
|---|---|---|
| HEATING (° C.) | 175.0 | 50 |
| CLOSING (s) | 5 | |
| HOLDING (s) | 1 | |
| OPENING (s) | 0.3 | |
| HOLDING (s) | 1 | |
| CLOSING (s) | 2 | |
| HOLDING (s) | 1 | |
| OPENING (s) | 0.3 | |
| CLOSING (s) | 2 | |
| HOLDING (min) | T₉₀ + 6 | |
| OPENING (s) | 4 | |

The vulcanization time corresponds to the value T90, which is determined as part of the determination of the cross-linking density/reaction kinetics, plus one minute per millimeter of test sample thickness (i.e., plus six when using the vulcanization mold in accordance with DIN ISO 815-1 type B). The vulcanized test specimens were immediately removed from the vulcanization mold to avoid uncontrolled further cross-linking. Care was taken to ensure that the test specimens were not damaged during removal. The use of tools to pry out the test samples was only permitted if damage to the test samples absolutely could be ruled out. The test specimens were placed on the cooling table for cooling. After cooling, the protruding edge was removed. Between vulcanization and testing, the samples were stored for at least 16 h at room temperature. The heating cabinet was preheated to test temperature. The load exposure time was 22 h, measured from the moment the compressive deformation unit was placed in the heating cabinet. The test temperature was 70° C. or 100° C. The applied compressive stress amounted to 25% of the initial thickness of the test specimen. As soon as the test temperature had been reached inside the heating cabinet, the central area of the heating cabinet was immediately loaded with the compressive deformation unit containing the test specimens after the compressive stress had been applied. After the required test duration had elapsed, the compressive deformation unit was removed from the heating cabinet along the lines of procedure A, the test specimens were immediately relieved from any load and quickly placed on the cooling table. They were left there for 30 minutes to recover and then measured for their thickness.

### 13. Determination of the Density of the Vulcanized Rubber Composition

The density of the vulcanized compound was determined according to ISO 2781:2018 Method A. Ethanol (96%) was used as the immersion medium. The results obtained represent the average value of three measurements. Between vulcanization and testing, the samples were stored for at least 16 h at room temperature.

### 14. Material Density of the Filler Employed

The material density of the filler was determined by means of a Helium pycnometer according to ISO 21687.

### 15. Determination of OH Groups Available on the Surface (OH Group Density)

Determination of the acidic hydroxyl groups available on the surface, including phenolic OH groups and phenolate groups, was carried out qualitatively and quantitatively colorimetrically according to Sipponen. The method according to Sipponen is based on the adsorption of the alkaline dye Azure B to the acidic hydroxyl groups accessible on the filler surface, and is described in detail in the paper “Determination of surface-accessible acidic hydroxyls and surface area of lignin by cation dye adsorption” (Bioresource Technology 169 (2014) 80-87). The amount of the acidic hydroxyl groups available on the surface is given in mmol/g of filler.

### Examples and Comparative Examples

The following examples and comparative examples serve to explain the invention, but should not be interpreted as limiting in any way.

### 1. Preparation of an Organic Filler Employed According to the Invention

1.1 As the organic filler according to the invention, a lignin L1 obtainable by hydrothermal treatment was used.

The lignin L1 obtainable by hydrothermal treatment was prepared according to the process for producing lignins that are obtainable by hydrothermal treatment, described in WO 2017/085278 A1.

For this purpose, a liquid containing lignin was provided. First, water and lignin are mixed, thus preparing a lignin-containing liquid with a content of organic dry mass of 15%. Subsequently, the lignin is largely dissolved in the lignin-containing liquid. For this purpose, the pH value is adjusted by adding NaOH. The preparation of the solution is promoted by intense mixing at 80° C. for 3 h. The lignin-containing liquid is subjected to a hydrothermal treatment, thus obtaining a solid matter. In the process, the solution prepared is heated to the reaction temperature of 220° C. with 2 K/min, which is then held over the reaction period of 8 h. Subsequently, cooling is performed. As a result, an aqueous suspension of solid matter is obtained. By filtration and washing, the solid matter is largely dewatered and washed. Subsequent drying and thermal treatment is carried out under nitrogen in a fluidized bed, wherein for drying the temperature was brought to 50° C. at 1.5 K/min and held for 2.5 h, and subsequently for thermal treatment the temperature was brought to 190° C. at 1.5 K/min and held for a period of 15 min and then cooled down again. The dried solid matter is de-agglomerated on a counter-jet mill with nitrogen to a d99 value <10 μm (determined according to the determination method described hereinabove).

The lignin L1 obtainable by hydrothermal treatment was characterized as indicated in Table 1.1 below, by means of the methods cited hereinabove.

TABLE 1.1
Properties of the lignin L1 obtainable by hydrothermal treatment

| Test | Unit | Lignin L1 |
|---|---|---|
| STSA | m²/g | 51.6 |
| BET | m²/g | 55.5 |
| ¹⁴C content | Bq/g C | 0.23 |
| Oxygen content | % by wt. | 20.7 |
| Carbon content | % by wt. | 72.7 |
| Ash content | % by wt. | 3.4 |
| pH value | ./. | 9.0 |
| Dry substance content | % by wt. | 97.9 |
| Material density | g/cm³ | 1.32 |
| d99 | μm | 5.51 |
| d90 | μm | 3.51 |
| d25 | μm | 0.80 |

1.2 In a similar way using the process described under 1.1, a second lignin L2 obtainable by hydrothermal treatment was prepared which was characterized as shown in Table 1.2 below by means of the methods cited hereinabove.

TABLE 1.2
Properties of the lignin L2 obtainable by hydrothermal treatment

| Test | Unit | Lignin L2 |
|---|---|---|
| STSA | m²/g | 44.7 |
| BET | m²/g | 49.1 |
| ¹⁴C content | Bq/g C | 0.23 |
| Oxygen content | % by wt. | 22.2 |
| Carbon content | % by wt. | 71.2 |
| pH value | ./. | 8.7 |
| OH-group density | [mmol/g] | 0.32 |
| Material density | g/cm³ | 1.33 |
| d97 | μm | 4.0 |
| d50 | μm | 1.1 |

1.3 In a similar way using the process described under 1.1, a third lignin L3 obtainable by hydrothermal treatment was prepared which was characterized as shown in Table 1.3 below by means of the methods cited hereinabove. In deviation from the process described under 1.1, however, the hydrothermal treatment was carried out in such a way that the prepared lignin-containing solution was heated with 1.5 K/min to a reaction temperature of 230° C., which was then held over a reaction period of 1 h. In addition, the lignin-containing liquid was modified using formaldehyde before the hydrothermal treatment was carried out. Finally, the final grinding was carried out on a steam-jet mill.

TABLE 1.3
Properties of the lignin L3 obtainable by hydrothermal treatment

| Test | Unit | Lignin L3 |
|---|---|---|
| STSA | m²/g | 43.3 |
| BET | m²/g | 48.3 |
| pH value | ./. | 8.8 |
| OH-group density | [mmol/g] | 0.14 |
| Material density | g/cm³ | 1.33 |
| d97 | μm | 5.6 |
| d50 | μm | 1.1 |

### 2. Preparation of Vulcanizable Rubber Compositions

2.1 Vulcanizable rubber compositions were prepared by means of a two-stage process.

In the first stage, a rubber composition as a base mixture (masterbatch) was prepared by compounding the constituents of the rubber composition according to the invention that comprised the rubber composition K and the filler component F. In the second stage the constituents of the cross-linking system (vulcanization system VS) were admixed.

### Stage 1

EPDM was employed as the rubber. Preparation of the EPDM-based rubber composition was carried out in the laboratory mixer from the company Haake, which has a chamber volume of 350 ml. The rubber was added first and kneaded for 1 min at 50 rpm. When using carbon black as the sole filler (comparative example KV1), 50% of this (together with 50% of the process oil employed) is added after 1 minute, and 50% after 3 minutes (together with the other 50% of the process oil employed). In case of the partial replacement of industrial carbon black by the filler employed according to the invention (examples KL1 and KL2 according to the invention), 100% of the organic filler employed according to the invention (together with 50% of the process oil used) are added after 1 minute and 100% of the industrial carbon black are added after 3 minutes (together with the other 50% of the process oil employed). In both cases, the remaining constituents of the base mixture (zinc oxide and stearic acid, cf. the following Table 2.1) were added after 3 minutes. After that, the constituents of the mixture were mixed dispersively and distributively until the mixing process was stopped after 10 min and the rubber composition was taken from the laboratory mixer. Under these mixing conditions, the rubber composition achieved a final temperature of 125° C. to 135° C. After the preparation of the rubber composition, it was cooled down before carrying out the second stage (maturing/storage).

By means of stage 1 described above, two rubber compositions employed according to the invention were obtained (KL1 and KL1) which both contained EPDM as the rubber of the rubber component K and lignin L1 obtained by hydrothermal treatment as the organic filler of the filler component. In addition, a comparative rubber composition was obtained in this way (KV1), which contained EPDM as the rubber of the rubber component K and only commercially available carbon black (and no lignin L1) as the organic filler of the filler component. The exact compositions of the rubber compositions can be seen from the following Table 2.1.

### Stage 2

In the second stage, the constituents of the cross-linking system were incorporated into the rubber composition of the first stage, whereby a vulcanizable rubber composition was obtained. Here, the mixtures KL1, KL2 and KV1, respectively, from the first stage were initially mixed again dispersively for 0-2 minutes. The addition of a vulcanization system (VS) was then carried out over a period of 2 to 2.5 minutes. For this purpose, an organic peroxide and a polyunsaturated organic compound used as a co-agent were employed as the VS. After addition, the mixture was mixed for additional 2.5 to 5 minutes. Here, the final temperature was between 90° C. and 100° C.

By means of stage 2 described above, two vulcanizable rubber compositions according to the invention (VKL1 and VKL1) were obtained after addition of the vulcanization system VS, which then can be vulcanized after completion of stage 2. In addition, a vulcanizable comparative rubber composition was obtained in this way (VKV1), which can also be vulcanized after completion of stage 2. The exact compositions of the vulcanizable rubber compositions can be seen from the following Table 2.1.

TABLE 2.1
Vulcanizable rubber compositions VKL1, VKL2 (according
to the invention) and VKV1 (comparative example)

| | Composition | Composition | Composition |
|---|---|---|---|
| | VKL1 | VKL2 | VKV1 |
| | (quantities in | (quantities in | (quantities in |
| | phr, resp.; | phr, resp.; | phr, resp.; |
| | acc. to the | acc. to the | not acc. to |
| Constituents | invention) | invention) | the invention) |
| EPDM | 150 | 150 | 150 |
| Organic filler L1 | 70 | 70 | — |
| Industrial | 60 | 60 | 130 |
| carbon black | | | |
| Process oil | 35 | 35 | 35 |
| Zinc oxide | 5 | 5 | 5 |
| Stearic acid | 2 | 2 | 2 |
| Co-agent | 2 | 2 | 2 |
| Peroxide | 7 | 8 | 7 |

The commercially available product Keltan® 4465 from the company Arlanxeo Deutschland GmbH was used as the EPDM (rubber of rubber component K). The commercially available product ZINKOXID Weisssiegel from the company Brüggemann was used as the zinc oxide. The commercially available product Palmera B 1805 from the company Avokal® GmbH was used as the stearic acid. As the industrial carbon black (filler of filler component F), the commercially available product LUVOMAXX BC N-550 from the company Lehmann & Voss & Co was used. The organic filler L1 has already been described hereinabove. The commercially available product Tudalen® 1927 from the company Hansen und Rosenthal KG was employed as the process oil. The commercially available product Di-Cup® 40 from the company Ashland was employed as the peroxide. Trimethylolpropanetri(meth)acrylate (TRIM) was employed as the co-agent.

2.2 Similar to the process described under 2.1, further vulcanizable rubber compositions VKL3, VKL4 and VKL5 (all according to the invention) and VKV2 (comparative example) were prepared in a single-stage approach.

EPDM was employed as the rubber. Preparation of the EPDM-based rubber composition was carried out in the laboratory mixer from the company Haake, which has a chamber volume of 350 ml. The rubber was provided first and kneaded for 1 min at 50 rpm. When using carbon black as the sole filler or when using the filler employed according to the invention as the sole filler, 50% of this was respectively added after 1 minute (together with 50% of the process oil employed, 100% of the calcium oxide employed, 100% of the chalk employed, 100% of the PEG employed and 100% of the stearic acid employed) and 50% after 4 minutes (together with the other 50% of the process oil used). In case of the partial replacement of industrial carbon black by the filler employed according to the invention, 100% of the filler employed according to the invention were added after 1 minute (together with 50% of the process oil employed, 100% of the calcium oxide employed, 100% of the chalk employed, 100% of the PEG employed and 100% of the stearic acid employed) and 100% of the industrial carbon black after 4 minutes (together with the other 50% of the process oil employed). After 6 minutes, a vulcanization system (VS) was then added. For this purpose, an organic peroxide and a polyunsaturated organic compound used as a co-agent were employed as the VS. After that, the constituents of the mixture were mixed dispersively and distributively until the mixing process was stopped after 10 min and the rubber composition was taken from the laboratory mixer. Under these mixing conditions, the rubber composition achieved a final temperature of 110° C. to 115° C.

The exact compositions of these vulcanizable rubber compositions can be seen from the following Table 2.2.

TABLE 2.2
Vulcanizable rubber compositions VKL3, VKL4 and VKL5 (all
according to the invention) and VKV2 (comparative example)

| | Composition | Composition | Composition | Composition |
|---|---|---|---|---|
| | VKL3 | VKL4 | VKL5 | VKV2 |
| | (quantities in | (quantities in | quantities in | (quantities in |
| | phr, resp.; | phr, resp.; | phr, resp.; | phr, resp.; |
| | acc. to the | acc. to the | acc. to the | not acc. to |
| Constituents | invention) | invention) | invention) | the invention) |
| EPDM | 100 | 100 | 100 | 100 |
| Organic | 50 | 50 | 100 | — |
| filler L2 | | | | |
| Industrial | 50 | 50 | — | 100 |
| carbon black | | | | |
| Chalk | 100 | 100 | 100 | 100 |
| Process oil | 100 | 100 | 100 | 100 |
| Stearic acid | 1 | 1 | 1 | 1 |
| PEG | 4 | 4 | 4 | 4 |
| Calcium | 6 | 6 | 6 | 6 |
| oxide | | | | |
| Co-agent | 2.9 | 2.9 | 2.9 | 2.9 |
| Peroxide | 8 | 10 | 10 | 8 |

The commercially available product Keltan® 5470C from the company Arlanxeo Deutschland GmbH was used as the EPDM (rubber of rubber component K). The commercially available product calcium carbonate Microcarb® LB10 T from the company Heinrich Heller GmbH was employed as chalk. The commercially available product Palmera B 1805 from the company Avokal® GmbH was used as the stearic acid. As the industrial carbon black (filler of filler component F), the commercially available product LUVOMAXX BC N-55 from the company Lehmann & Voss & Co was used. The organic filler L2 has already been described hereinabove. The commercially available product Tudalen® 1927 from the company Hansen und Rosenthal KG was employed as the process oil. The commercially available product Di-Cup® 40 from the company Ashland was employed as the peroxide. Trimethylolpropantri(meth)acrylate (TRIM) was employed as the co-agent. Polyethylene glycol 4000 was used as PEG. The commercially available product Kezadol® GR 80 from the company Kettliz GmbH was used as the calcium oxide. 2.3 Similar to the process described under 2.1, further vulcanizable rubber compositions VKL6 and VKL7 (all according to the invention) and VKV3 (comparative example) were prepared in a single-stage mixing approach. In the case of VKV3, however, a different vulcanization system (VS) was used instead of peroxide (and co-agent), namely sulfur (as well as three different accelerators B1, B2 and B3).

EPDM was employed as the rubber. Preparation of the EPDM-based rubber composition was carried out in the laboratory mixer from the company Haake, which has a chamber volume of 350 ml. The rubber was provided first and kneaded for 1 min at 50 rpm. When using peroxide as VS (VKL6 and VKL7), 50% of the filler employed according to the invention was added to this after 1 minute (together with 50% of the process oil used, 100% of the zinc oxide used and 100% of the stearic acid used) and then the remaining 50% of the filler was added to the resulting mixture after 4 minutes (together with the other 50% of the process oil used; see Table 2.3). After 6 minutes, a vulcanization system (VS) was then added. For this purpose, an organic peroxide and a polyunsaturated organic compound used as a co-agent were employed as the VS. After that, the constituents of the mixture were mixed dispersively and distributively until the mixing process was stopped after 10 min and the rubber composition was taken from the laboratory mixer. Under these mixing conditions, the rubber composition achieved a final temperature of 110° C. to 115° C. VKV3 (comparative example) was produced in a similar way. In this case, sulfur and the three different accelerators B1, B2 and B3 were added in doses instead of peroxide (and co-agent) after 6 minutes. After that, the constituents of the mixture were mixed dispersively and distributively until the mixing process was stopped after 10 min and the rubber composition was taken from the laboratory mixer. Under these mixing conditions, the rubber composition achieved a final temperature of 108° C.

The exact compositions of these vulcanizable rubber compositions can be seen from the following Table 2.3.

TABLE 2.3
Vulcanizable rubber compositions VKL6 as well as VKL7 (all
according to the invention) and VKV3 (comparative example)

| | Composition | Composition | Composition |
|---|---|---|---|
| | VKL6 | VKL7 | VKV3 |
| | (quantities in | (quantities in | (quantities in |
| | phr, resp.; | phr, resp.; | phr, resp.; |
| | acc. to the | acc. to the | not acc. to |
| Constituents | invention) | invention) | the invention) |
| EPDM | 100 | 100 | 100 |
| Organic | 80 | 80 | 80 |
| filler L3 | | | |
| Process oil | 40 | 40 | 40 |
| Stearic acid | 2 | 2 | 2 |
| Zinc oxide | 5 | 5 | 5 |
| Co-agent | 2.9 | 2.9 | — |
| Peroxide | 8 | 10 | — |
| Accelerator B1 | — | — | 1.3 |
| Accelerator B2 | — | — | 1.1 |
| Accelerator B3 | — | — | 3.5 |
| Sulfur | — | — | 1 |

The commercially available product Keltan® 5470C from the company Arlanxeo Deutschland GmbH was used as the EPDM (rubber of rubber component K). The commercially available product Palmera B 1805 from the company Avokal® GmbH was used as the stearic acid. The organic filler L3 has already been described hereinabove. The commercially available product Tudalen® 1927 from the company

Hansen und Rosenthal KG was employed as process oil. The commercially available product Di-Cup® 40 from the company Ashland was employed as the peroxide. Trimethylolpropantri(meth)acrylate (TRIM) was employed as the co-agent. The commercially available product ZINKOXID Weisssiegel from the company Brüggemann was used as the zinc oxide. Struktol@ SU95 from the company Schill+Seilbacher was used as sulfur (cross-linking agent). The products MBTS 80 GE F GREEN from the company Vibiplast S.r.l. (B1), Rhenogran® ZBEC-70 from the company RheinChemie Additive (B2) and Rhenogran® TP-50 from the company RheinChemie Additive (B3) were used as accelerators.

### 3. Examinations and Tests of the Vulcanizable Rubber Compositions and Vulcanized Rubber Compositions Obtainable Therefrom

### 3.1 Cross-Linking Density and Reaction Kinetics

The rubber compositions obtained after the second stage were examined with regards to the properties of their raw mixtures. Here the reaction kinetics and the cross-linking density were measured according to the method described hereinabove.

Tables 3.1 and 3.2 summarize the results obtained with regard to minimum and maximum torque (M_{L}, M_{H}), difference A (M_{H}-M_{L}) and the time periods T10, T50 and T90.

TABLE 3.1

| | VKL1 | VKL2 | VKV1 |
|---|---|---|---|
| | (according | (according | (not according |
| | to the | to the | to the |
| Parameters | invention) | invention) | invention) |
| T₁₀ [min] | 0.62 | 0.59 | 0.62 |
| T₅₀ [min] | 1.41 | 1.27 | 1.44 |
| T₉₀ [min] | 3.31 | 3.05 | 3.31 |
| M_{L} [dNm] | 6.29 | 6.43 | 5.83 |
| M_{H} [dNm] | 27.19 | 29.57 | 33.00 |
| Δ (M_{H} − M_{L}) [dNm] | 20.90 | 23.14 | 27.17 |

Compared to VKV1, the rubber compositions according to the invention VKL1 and VKL2 show comparable reaction kinetics (T₁₀, T₅₀, T₉₀). Minor deviations occur in the cross-linking density, which represents the difference A (M_{H}-M_{L}) between the maximum and minimum torque in dNm.

TABLE 3.2

| | VKL3 | VKL4 | VKL5 | VKV2 |
|---|---|---|---|---|
| | (according | (according | (acc. | (not acc. |
| | to the | to the | to the | to the |
| Parameters | invention) | invention) | invention) | invention) |
| T₁₀ [min] | 0.99 | 0.90 | 0.91 | 0.91 |
| T₅₀ [min] | 2.94 | 2.62 | 2.73 | 2.51 |
| T₉₀ [min] | 11.5 | 11.7 | 12.3 | 8.4 |
| M_{L} [dNm] | 0.82 | 0.79 | 0.92 | 0.69 |
| M_{H} [dNm] | 9.55 | 10.68 | 10.24 | 9.73 |
| Δ (M_{H} − M_{L}) [dNm] | 8.73 | 9.89 | 9.32 | 9.04 |

Compared to VKV2, the rubber compositions according to the invention VKL3, VKL4 and VKL5 show comparable reaction kinetics with respect to T₁₀ and T₅₀ as well as a comparable cross-linking density, which represents the difference Δ (M_{H}-M_{L}) between the maximum and minimum torque in dNm. Deviations arise with regard to T₉₀.

### 3.2 Tensile Strength, Elongation at Break and Shore a Hardness, as Well as Compression Sets

The rubber compositions obtained after the second stage were vulcanized isothermally at 175° C. for 6 minutes (VKV1, VKL1 and VKL2). The rubber compositions obtained after one stage were vulcanized at 170° C., for 11 (VKV2), 14 (VKL3 and VKL4) or 15 (VKL5) minutes, respectively. Tensile strength, elongation at break, moduli 100 to 300 and Shore A hardness as well as compression set were then determined according to the methods described hereinabove.

Tables 3.3 and 3.4 summarize the results obtained.

TABLE 3.3

| | VKL1 | VKL2 | VKV1 |
|---|---|---|---|
| | (according | (according | (not according |
| | to the | to the | to the |
| Parameters | invention) | invention) | invention) |
| Tensile strength [MPa] | 9.0 | 10.3 | 11.7 |
| Modulus 100 [MPa] | 1.7 | 2.1 | 1.8 |
| Modulus 200 [MPa] | 4.4 | 5.3 | 5.3 |
| Modulus 300 [MPa] | 6.7 | 7.8 | 9.1 |
| Elongation at break [%] | 420 | 393 | 364 |
| Shore A hardness | 59 | 60 | 59 |
| Compression set 22 h, | 12.8 | 10.8 | 13.9 |
| 70° C. [%] | | | |
| Compression set 22 h, | 19.1 | 18.1 | 20.3 |
| 100° C. [%] | | | |

The tensile-elongation behavior shows that, compared to VKV1, the tensile strength of the rubber compositions according to the invention VKL1 and VKL2 is lower, but the elongation at break is significantly increased. In the case of peroxide cross-linking, the elongation at break depends on the cross-linking density and therefore on the dosage of the cross-linking constituents. The comparatively lower cross-linking density can be seen from Table 3.1. It is interesting to note that if the cross-linking density is adjusted, higher modulus values are achieved with VKL2 at low elongations as compared to VKV1. It is the low elongation range in particular that is important for a rubber article, because these elongations occur during use. What is special about the technical rubber data, however, is that despite the comparatively low cross-linking density for the rubber compounds VKL1 and VKL2 containing the organic filler L1, the values for the compression set are lower at both 70° C. and 100° C. compared to the composition VKV1, which has a higher cross-linking density.

With the same dosage of peroxide and co-agent (VKV1 vs. VKL1), the use of L1 achieves an improved compression set (lower) and at the same time a significantly higher elongation at break with the same hardness (Shore A). Even a slight increase in the peroxide dosage (VKL2) shows a further improvement in the compression set, although the elongation at break is still significantly higher than that of VKV1. With rubber compositions containing L1, the tensile-elongation values and the compression set can be flexibly adjusted. Another advantage of the rubber compositions VKL1 and VKL2 is that the stress values can be set up to around 200% higher at low elongations and this at a higher elongation at break than in the case of VKV1 (see module 100 of VKL2). This improves the sealing function.

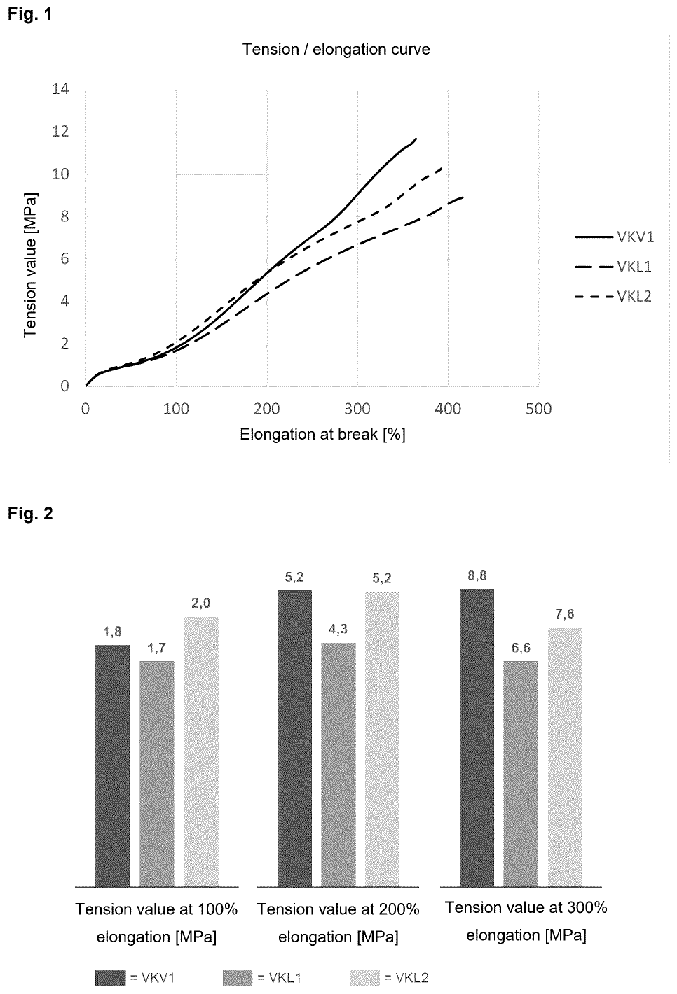

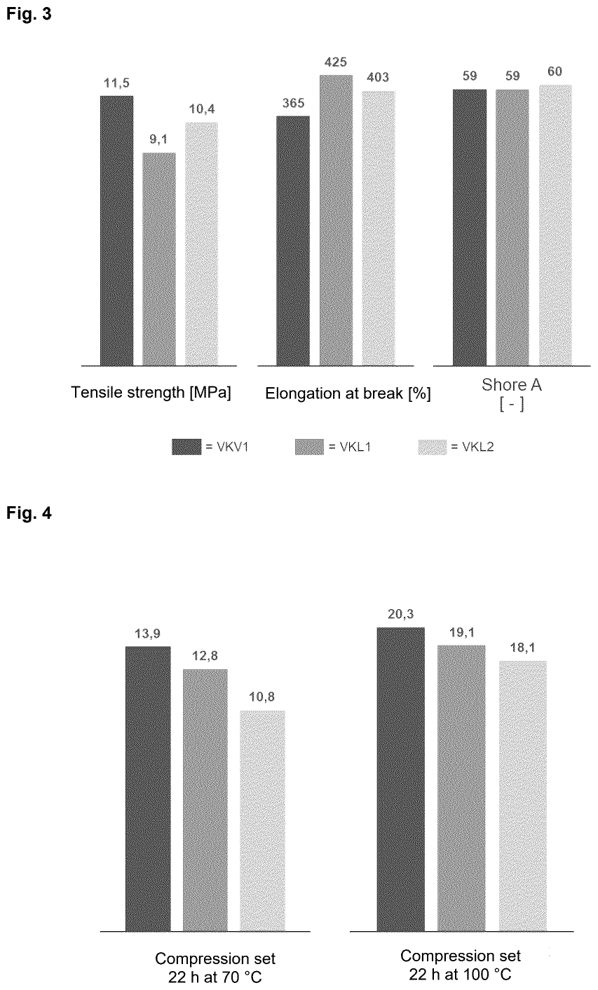

The results shown in Table 3.3 are graphically illustrated in the figures FIG. 1, FIG. 2, FIG. 3, and FIG. 4. FIG. 1 provides an overview of the tensile-elongation behavior determined. FIG. 2 provides an overview of the stress values determined at 100, 200 and 300% elongation. FIG. 3 provides an overview of the values determined for tensile strength, elongation at break and Shore A hardness. FIG. 4 provides an overview of the values determined for the compression set at different temperatures.

TABLE 3.4

| | VKL3 | VKL4 | VKL5 | VKV2 |
|---|---|---|---|---|
| | (acc. | (acc. | (acc. | (not acc. |
| | to the | to the | to the | to the |
| Parameters | invention) | invention) | invention) | invention) |
| Tensile strength [MPa] | 6.7 | 7 | 5.7 | 8.1 |
| Modulus 100 [MPa] | 1.7 | 1.8 | 1.6 | 1.9 |
| Modulus 200 [MPa] | 3.3 | 3.5 | 2.8 | 4.1 |
| Modulus 300 [MPa] | 5 | 5.2 | 4.2 | 6.4 |
| Elongation at break [%] | 476 | 464 | 489 | 387 |
| Shore A hardness | 65 | 65 | 64 | 65 |
| Compression set 22 h, | 21.5 | 18.2 | 19.2 | 21.5 |
| 70° C. [%] | | | | |
| Density [g/cm³] | 1.21 | 1.22 | 1.18 | 1.25 |

The tensile-elongation behavior also shows here that, compared to VKV2, the tensile strength of the rubber compositions according to the invention VKL3, VKL4 and VKL5 is somewhat lower, but the elongation at break is advantageously significantly increased. The data also show, in particular, that for the rubber compounds VKL4 and VKL5 containing the organic filler L2 the values for the compression set at 70° C. are advantageously lower compared to the composition VKV2.

3.3 Compression Set when Comparing Peroxide Cross-Linking Vs. Sulfur Cross-Linking (VKL6 and VKL7 vs. VKV3)

The rubber compositions VKL6 and VKL7 as well as VKV3 obtained after one stage were vulcanized isothermally at 170° C. for 8.5 (VKL6 and VKL7) and 13 (VKV3) minutes, respectively. The respective compression set was then determined both for 22 h at 70° C. and for 22 h at 100° C., according to the method described hereinabove. The results are shown in Table 3.5.

TABLE 3.5

| | VKL6 | VKL7 | VKV3 |
|---|---|---|---|
| | (acc. | (acc. | (not acc. |
| | to the | to the | to the |
| Parameters | invention) | invention) | invention) |
| Compression set 22 h, | 17.3 | 16.1 | 21.1 |
| 70° C. [%] | | | |
| Compression set 22 h, | 17.7 | 15.6 | 58.6 |
| 100° C. [%] | | | |

A comparison of the data shows in particular that the compression set values at 70° C. and 100° C. for the rubber compounds VKL6 and VKL7 cross-linked by means of peroxide and containing the organic filler L3 are advantageously lower than in the case of the comparative compound VKV3 cross-linked by means of sulfur.

1. A vulcanizable rubber composition comprising a rubber component K, a filler component F and a vulcanization system VS, wherein
the vulcanization system VS comprises at least one peroxide,
the rubber component K contains at least one rubber that is cross-linkable by means of the at least one peroxide of the vulcanization system VS, and
the filler component F contains at least one organic filler that has a ¹⁴C content in a range from 0.20 to 0.45 Bq/g carbon and a d99 value of <25.0 μm.

2. The rubber composition according to claim 1, wherein the organic filler has a d99 value of <20.0 μm, which is optionally determined by means of laser diffraction according to ISO 13320:2009.

3. The rubber composition according to claim 2, wherein the organic filler has a d90 value of <7.0 μm.

4. The rubber composition according to claim 1, wherein the organic filler has a BET surface area in a range from 10 to 150 m²/g.

5. The rubber composition according to claim 1, wherein the organic filler has an oxygen content in a range from >8% by weight to <30% by weight, relative to the ash-free and water-free filler.

6. The rubber composition according to claim 1, wherein the organic filler has a carbon content in a range from >60% by weight to <90% by weight, relative to the ash-free and water-free filler.

7. The rubber composition according to claim 1 comprising the at least one organic filler in a quantity in a range from 10 to 150 phr.

8. The rubber composition according to claim 1, wherein the organic filler is a lignin-based filler.

9. The rubber composition according claim 1, wherein the at least one peroxide of the vulcanization system VS comprises at least one organic peroxide.

10. The rubber composition according to claim 1, wherein the at least one rubber of the rubber component K is selected from the group consisting of rubbers without carbon-carbon double bonds in their main chain, or without any carbon-carbon double bonds within their whole structure.

11. The rubber composition according to claim 1, further comprising at least one monounsaturated or polyunsaturated organic compound that is part of the vulcanization system VS of the rubber composition, and that is selected from the group consisting of di-(meth)acrylates, dimaleinimides, triallyl compounds and unsaturated polymers, and optionally has a number-average molecular weight (Mn) of <10,000 g/mol.

12. A kit of parts, comprising, in spatially separated form,
as part (A), a rubber composition at least comprising a rubber component K that is cross-linkable by at least one peroxide of a vulcanization system VS and at least a filler component F containing at least one organic filler that has a ¹⁴C content in a range from 0.20 to 0.45 Bq/g carbon and a d99 value of <25.0 μm, wherein part (A) does not comprise, however, the at least one peroxide of the vulcanization system VS and
as part (B), the vulcanization system VS comprising the at least one peroxide.

13. A vulcanized rubber composition, which is obtainable by vulcanization of the vulcanizable rubber composition according to claim 1.

14. A method comprising: obtaining a vulcanizable rubber composition or a vulcanized rubber composition; and producing one or more technical rubber articles from the vulcanizable rubber composition or the vulcanized rubber composition, including technical rubber articles having a sealing function, in particular of seals, profiles, dampers, rings and hoses, wherein:
the vulcanizable rubber composition is obtained by one of the following:
the vulcanizable rubber composition of claim 1; or
a kit of parts, comprising, in spatially separated form: as part (A), a rubber composition at least comprising a rubber component K that is cross-linkable by at least one peroxide of a vulcanization system VS and at least a filler component F containing at least one organic filler that has a ¹⁴C content in a range from 0.20 to 0.45 Bq/g carbon and a d99 value of <25.0 μm, wherein part (A) does not comprise, however, the at least one peroxide of the vulcanization system VS; and as part (B), the vulcanization system VS comprising the at least one peroxide;
or
the vulcanized rubber composition is obtained by one of the following:
vulcanizing a mixture of a vulcanization system VS comprising at least one peroxide, a rubber component K containing at least one rubber that is cross-linkable by means of the at least one peroxide of the vulcanization system VS, and a filler component F containing at least one organic filler that has a ¹⁴C content in a range from 0.20 to 0.45 Bq/g carbon and a d99 value of <25.0 μm; or
vulcanizing part (A) and part (B) of a kit of parts, comprising, in spatially separated form: as the part (A), a rubber composition at least comprising a rubber component K that is cross-linkable by at least one peroxide of a vulcanization system VS and at least a filler component F containing at least one organic filler that has a ¹⁴C content in a range from 0.20 to 0.45 Bq/g carbon and a d99 value of <25.0 μm, wherein part (A) does not comprise, however, the at least one peroxide of the vulcanization system VS; and as the part (B), the vulcanization system VS comprising the at least one peroxide.

15. A technical rubber article, including a technical article having a sealing function, including a seal, profile, damper, ring, or hose, produced by using a vulcanizable rubber composition according to claim 1, or a kit of parts, comprising, in spatially separated form: as part (A), a rubber composition at least comprising a rubber component K that is cross-linkable by at least one peroxide of a vulcanization system VS and at least a filler component F containing at least one organic filler that has a ¹⁴C content in a range from 0.20 to 0.45 Bq/g carbon and a d99 value of <25.0 μm, wherein part (A) does not comprise, however, the at least one peroxide of the vulcanization system VS; and as part (B), the vulcanization system VS comprising the at least one peroxide.

16. A method for increasing elongation at break and at the same time decreasing a compression set in a vulcanized rubber compositions that is obtainable by vulcanization by means of at least one peroxide, the method comprising: mixing a filler component F containing at least one organic filler that has a ¹⁴C content in a range from 0.20 to 0.45 Bq/g carbon and a d99 value of <25.0 μm with a rubber component K with a vulcanization system VS comprising the at least one peroxide, at least one rubber component K that is cross-linkable by means of the at least one peroxide.

17. The rubber composition according to claim 8, wherein at least the lignin and/or the organic filler as such, is present at least partially in a form that can be obtained by means of hydrothermal treatment, which has been optionally carried out at a temperature in a range from >100° C. to <300° C.

18. The rubber composition according to claim 1, wherein:
the at least one peroxide of the vulcanization system VS comprises: an organic peroxide selected from the group consisting of: dialkyl peroxides, alkyl aryl peroxides, diaryl peroxides, alkyl peracid esters, aryl peracid esters, diacyl peroxides, polyvalent peroxides and mixtures thereof, particularly preferably an organic peroxide selected from the group consisting of di-tert.-butylperoxide, 2,5-dimethyl-2,5-di(tert.-butyl-peroxy) hexane, dicumyl peroxide, tert.-butylcumyl peroxide, tert.-butyl peroxybenzoate, dibenzoyl peroxide, 1,1-di(tert.-butylperoxy)-3,3,5-trimethyl cyclohexane and bis-(tert.-butylperoxy)-diisopropylbenzene as well as mixtures thereof; and/or
the at least one rubber of the rubber component K is selected from the group consisting of: HNBR (hydrated acrylonitrile-butadiene rubbers), ethylene-propylene-diene rubbers (EPDM), ethylene-propylene rubbers (EPM), acrylate-ethylene rubbers (AEM), ethylene-vinyl acetate rubbers (EVM), chlorinated rubbers, in particular chlorinated polyethylenes (CM), silicone rubbers (Q), chlorosulfonated polyethylenes (CSM), fluoro-rubber elastomers (FPM) and mixtures thereof; and/or
the rubber composition comprises at least one monounsaturated or polyunsaturated organic compound that is part of the vulcanization system VS of the rubber composition, and that is selected from the group consisting of: ethylene glycoldi(meth)acrylate (EDMA), trimethylolpropane tri(meth)acrylate (TRIM), N,N′-m-phenylene bismaleimide (MPBM), diallylterephthalate (DATP), triallylcyanurate (TAC), 1,4-butandiol di(meth)acrylate and mixtures thereof.

19. A vulcanized rubber composition, which is obtainable by vulcanization of a vulcanizable rubber composition obtainable by combining and mixing both parts (A) and (B) of the kit of parts according to claim 12.

20. A technical rubber article, including a technical rubber article having a sealing function including a seal, profile, damper, ring, or hose, produced by using a vulcanized rubber composition according to either claim 13 or a vulcanized part (A) and part (B) of a kit of parts, which comprises, in spatially separated form: as part (A), a rubber composition at least comprising a rubber component K that is cross-linkable by at least one peroxide of a vulcanization system VS and at least a filler component F containing at least one organic filler that has a ¹⁴C content in a range from 0.20 to 0.45 Bq/g carbon and a d99 value of <25.0 μm, wherein part (A) does not comprise, however, the at least one peroxide of the vulcanization system VS; and as part (B), the vulcanization system VS comprising the at least one peroxide.
